(19) United States
(12) Patent Application Publication
(10) Pub. No.: US 2007/0189763 A1
(43) Pub. Date: Aug. 16, 2007

(54) Multi-direction image capture apparatus

(76) Inventors: Masakatsu Kojima, Yokohama-shi (JP); Shigeru Yamamoto, Yokohama-shi (JP)

Correspondence Address: MOTOROLA INC, 600 NORTH US HIGHWAY 45, ROOM AS437, LIBERTYVILLE, IL, 60048-5343, US

(21) Appl. No.: 11/355,129

(22) Filed: Feb. 15, 2006

(51) Int. Cl. G03B 15/00

(52) U.S. Cl. 396/351

(57) ABSTRACT

A multi-direction image capture apparatus is useful for capturing images through either a primary aperture (125) or a secondary aperture (300) using only a single image sensor (205). The apparatus includes a housing (105) that includes the primary aperture (125) and the secondary aperture (300). An image sensor (205) is positioned in the housing (105) and has a light sensitive data capture surface (315) facing the primary aperture (125). A one-way mirror (130) faces the light sensitive data capture surface (315) of the image sensor (205). Thus light passing through the primary aperture (125) passes through the one-way mirror (130) and impacts the light sensitive data capture surface (315) of the image sensor (205), and light passing through the secondary aperture (300) is reflected off the one-way mirror (130) and impacts the light sensitive data capture surface (315) of the image sensor (205).

### FIELD OF THE INVENTION

The present invention relates generally to image capturing using digital cameras. In particular, although not exclusively, the invention relates to capturing images from multiple directions using a single image sensor.

### BACKGROUND OF THE INVENTION

Increased miniaturization of digital camera technology has resulted in the widespread use of digital cameras in various handheld electronic devices. Digital cameras are now commonly incorporated for example into mobile phones, personal digital assistants (PDAs), and notebook computers. Such general availability of digital cameras has spawned many novel applications for digital images. For example, mobile phones incorporating digital cameras can be used as personal security devices, enabling parents to use digital images to closely monitor the location and environment of their young children.

Some electronic devices that incorporate a digital camera include components that enable digital images to be captured from multiple directions. For example, multiple digital camera image sensors, mechanically rotatable camera lenses, or “fish-eye” lenses can be used to capture images both in front of and behind a device. Capturing images from different directions relative to a device can be useful for features such as video conferencing, security monitoring, image previewing using a display screen, and capturing panoramic images. However, prior art components for capturing images from different directions relative to a device are generally complex, such as multiple digital image sensors or rotatable lenses, or are generally expensive, such as the advanced optics required of high-quality “fish-eye” lenses.

### SUMMARY OF THE INVENTION

According to one aspect, the present invention is a multi-direction image capture apparatus that includes a housing having a primary aperture and a secondary aperture. An image sensor is positioned in the housing and has a light sensitive data capture surface facing the primary aperture. A one-way mirror faces the light sensitive data capture surface of the image sensor. Light passing through the primary aperture passes through the one-way mirror and impacts the light sensitive data capture surface of the image sensor, and light passing through the secondary aperture is reflected off the one-way mirror and impacts the light sensitive data capture surface of the image sensor.

The present invention therefore provides a multi-direction image capture apparatus that enables images to be captured through either the primary aperture or the secondary aperture using only a single image sensor. In various circumstances the apparatus can, for example, rotate randomly about a lanyard hung around a user's neck and yet always capture images of objects positioned in front of the user, without requiring any adjustments to the components of the apparatus. Further, the primary aperture or the secondary aperture can be covered deliberately by a user so as to select a particular image capture direction. Suitably, the one-way mirror can be parabolic and the light sensitive data capture surface is positioned at a focal point of the one-way mirror.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 illustrated a front plan view of a mobile telephone that includes a digital camera, according to an embodiment of the present invention;

FIG. 2 is a schematic diagram illustrating a perspective view of relative positions of several components of a digital camera of a mobile telephone, according to an embodiment of the present invention;

FIG. 3 is a schematic diagram illustrating a top sectional view through 3-3 of the mobile telephone of FIG. 1, where a secondary lens that is part of the telephone is occluded, according to an embodiment of the present invention;

FIG. 4 is a schematic diagram illustrating a top sectional view through 3-3 of the mobile telephone of FIG. 1, where a one-way mirror that is part of the telephone is occluded, according to an embodiment of the present invention;

FIG. 5 is a schematic diagram illustrating a top sectional view of a second embodiment of a mobile telephone of where a secondary lens that is part of the telephone is occluded; and

FIG. 6 is a schematic diagram illustrating a top sectional view of the second embodiment of a mobile telephone where a one-way mirror that is part of the telephone is occluded.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a multi-direction image capture apparatus. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, primary and secondary, first and second, front and rear, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

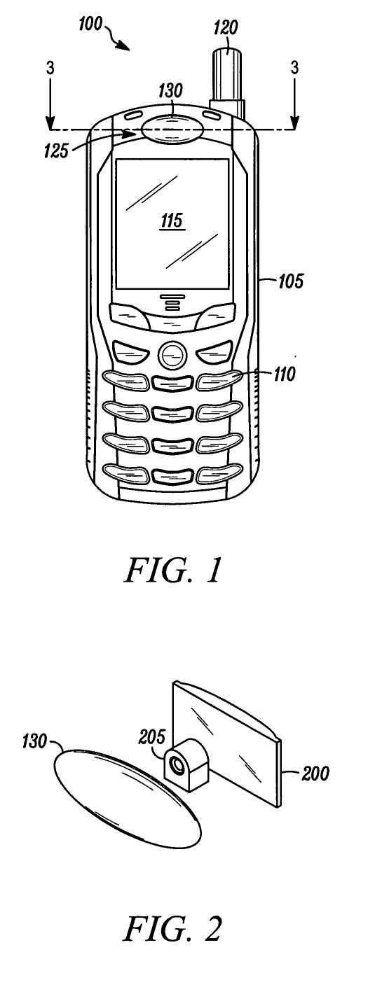

Referring to FIG. 1, a schematic diagram illustrates a front of a mobile telephone 100 that includes a digital camera, according to an embodiment of the present invention. As with many wireless communication devices, the telephone 100 includes a housing 105, a keypad 110, a display screen 115 and an antenna 120. In addition to the above, the telephone 100 has a primary aperture 125 is disposed in the housing 105, and the aperture 125 is covered by a one-way mirror 130 that reflects incident light on one side and allows incident light on the other side to pass through the one-way mirror 130. It will therefore be apparent to a person skilled in the art, by referring to the remainder of this specification, that one side of the one-way mirror 130 functions as a reflector for a digital camera and the other side operates as a lens of the same digital camera.

Referring to FIG. 2, a schematic diagram illustrates perspective view of relative positions of several components of the digital camera of the mobile telephone 100, according to an embodiment of the present invention. The components include the one-way mirror 130, a secondary lens 200, and an image sensor 205 positioned in the housing 105 between the one-way mirror 130 and the secondary lens 200. As described in more detail below, the one-way mirror 130 enables the telephone 100 to function as a multi-direction camera that can capture images both in front of and behind the telephone 100.

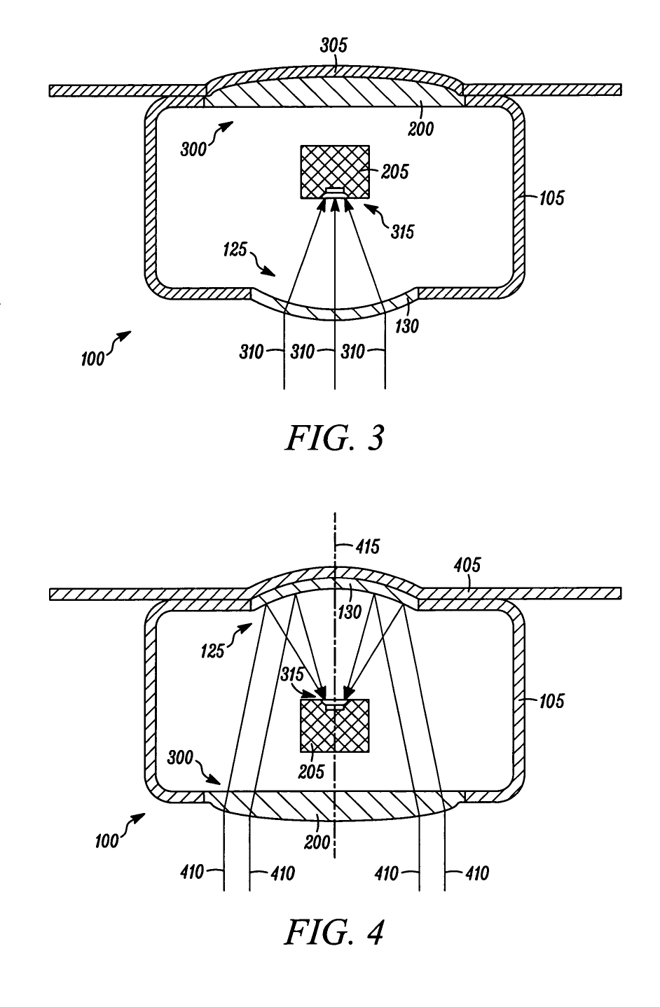

Referring to FIG. 3, a schematic diagram illustrates a top sectional view through 3-3 of the mobile telephone 100 where the secondary lens 200 is occluded, according to an embodiment of the present invention. The image sensor 205 is shown positioned in the housing 105 between the secondary lens 200 and the one-way mirror 130. The secondary lens 200 is shown positioned in a secondary aperture 300 on an opposite side of the housing 105 to that of the primary aperture 125 within which the one-way mirror 130 suitably resides, thus the one-way mirror 130, secondary lens 200 and image sensor 205 are in alignment. Also, as illustrated, the secondary lens 200 is occluded by a secondary defilade object 305. The secondary defilade object 305 can be any object, such as a lens cover or even the body of a user of the telephone 100, which blocks light from passing through the secondary aperture 300.

Light rays 310 passing through the one-way mirror 130 are focused directly onto a light sensitive data capture surface 315 of the image sensor 205. The light sensitive data capture surface 315 comprises a light sensitive medium, such as a charge coupled device (CCD) or complementary metal oxide semiconductor (CMOS) device, which enables detection of the light rays 310 and recording of a photographic image of a scene in front of the telephone 100.

Referring to FIG. 4, a schematic diagram illustrates the top sectional view top sectional view through 3-3 of the mobile telephone 100 where the one-way mirror 130 is occluded, according to an embodiment of the present invention. The image sensor 205 is again shown positioned in the housing 105 between the secondary lens 200 and the one-way mirror 130. The one-way mirror 130 is shown positioned in the primary aperture 125 that is occluded by a primary defilade object 405. Similar to the secondary defilade object 305, the primary defilade object 405 also can be any object, such as a lens cover or even the body of a user of the telephone 100, which blocks light from passing through the primary aperture 125. Light rays 410 passing through the secondary aperture 300 are reflected off the one-way mirror 130, and are then focused onto the light sensitive data capture surface 315 of the image sensor 205.

According to the present embodiment, the one-way mirror 130 is generally parabolic, and the light sensitive data capture surface 315 is positioned near a focal point of the one-way mirror 130. That means that both light rays 310 passing through the primary aperture 125, and light rays 410 passing through the secondary aperture 300 are both focused by the parabolic shape of the one-way mirror 130 and are directed generally to the light sensitive data capture surface 315.

Therefore, according to an embodiment of the present invention, simply by covering or uncovering, respectively, the primary aperture 125 or the secondary aperture 300, the mobile telephone 100 is able to capture images in opposite directions relative to a front of the telephone 100. Where the secondary defilade object 305 and the primary defilade object 405 do not form part of the telephone 100, but rather comprise external objects such as a user's body, the telephone 100 is able to capture images in opposite directions without any adjustments to electronic circuitry or movement of physical components. Further, only a single operative lens, in the form of the one-way mirror 130, is used for focusing the light rays 310, 410, and a single image sensor 205 is used to sense the light rays 310, 410. The complexity and cost of a multi-direction image capture apparatus, such as the telephone 100, is thus significantly reduced compared to the prior art.

Also shown in FIG. 4 is a centerline 415 that passes through a center of the primary aperture 125 and a center of the secondary aperture 300. In the embodiment of the present invention illustrated in FIG. 4, the light sensitive data capture surface 315 of the image sensor 205 is aligned so that the centerline 415 also passes through a center of the light sensitive data capture surface 315. Based on the present disclosure, those skilled in the art will appreciate that according to alternative embodiments of the present invention the light sensitive data capture surface 315 of the image sensor 205 also can be offset so that the centerline 415 does not pass through the center of the light sensitive data capture surface 315.

To capture identical image, the telephone 100 is first faced toward the objects in the images with the secondary aperture 300 occluded, and an image capture feature of the phone 100, such as a shutter button, is activated. The phone 100 can alternatively be simply rotated 180 degrees about its longitudinal axis, and the image capture feature is again activated, but with the primary aperture 125 occluded and the secondary aperture 300 unobstructed and faced toward the objects in the images.

Capturing images from multiple directions, as enabled by the present invention, is useful in many different circumstances. For example, an electronic device such as the mobile telephone 100 is sometimes suspended from a lanyard that is worn around the neck of a user. Where the user is a child, such a “necklace” phone 100 can function as a personal security device that enables parents or guardians to monitor the activities of the child, such as when the child is at a daycare or with a babysitter. The phone 100 can be programmed to periodically capture images using the image sensor 205 and transmit the images to another device in the possession of the parent or guardian. In such circumstances, regardless of how the phone 100 rotates about the lanyard, the oblong shape of the housing 105 will generally keep either the primary aperture 125 or the secondary aperture 300 pressed against the user's chest. The user's chest thus can act as both a secondary defilade object 305 and a primary defilade object 405 according to the embodiment described herein. Thus regardless of which direction the phone 100 is facing relative to the user, the phone 100 will usually capture an image that is generally in front of the user.

Embodiments of the present invention are also useful in other circumstances, such as where a user of the mobile telephone 100 employs the display screen 115 as a camera viewfinder. Similar to many digital cameras known in the art, the display screen 115 can display in real-time an image of a scene that is captured by the image sensor 315. Typically, real-time images displayed on the display screen 115 are transient only and are captured in a memory of the telephone 100 only when a user activates an image capture triggering mechanism. Thus the display screen 115 is useful as an image preview window. Further, the display screen 115 can preview images captured through either the primary aperture 125 or the secondary aperture 300. When images are captured through the primary aperture 125, the telephone 100 enables previewing of “self portrait” images, because both the primary aperture 125 and the display screen 115 are facing a user.

Users of conventional digital cameras or camera phones that comprise a display screen on one side and a camera lens on another side, are unable to preview “self-portrait” images using the display screen. Some prior art devices overcome that disadvantage by providing multiple image sensors and lenses on a single device, or by enabling a display screen and a camera lens to physically rotate relative to each other. However, such solutions can be expensive to implement as they require additional sensors or additional complex moving parts.

According to an embodiment of the present invention, the housing 105 of the telephone 100 can also comprise a moveable defilade cover that acts as the secondary defilade object 305, and another moveable defilade cover that acts as the primary defilade object 405. The covers can be activated either manually or automatically to cover, respectively, the secondary aperture 300 or the primary aperture 125, thus enabling the direction perceived by the image sensor 205 to be changed using very simple moving parts. Thus when a user of the telephone 100 seeks to preview a “self-portrait” image, a cover is placed over the secondary aperture 300 and another cover is removed from the primary aperture 125. The user then holds the telephone 100 so that both the display screen 115 and the primary aperture 125 are facing the user.

Alternatively, as described above, the rear and primary defilade objects 305, 405 can comprise objects not connected to the housing 105 such as a user's body, clothing, or hand, or various other types of objects. Still other embodiments of the present invention can use thin films, such as polarizable thin films, applied directly to the one-way mirror 130 or to the secondary lens 200 to function, respectively, as the primary defilade object 405 or as the secondary defilade object 305.

Those skilled in the art will recognize that miniaturization of digital camera technology enables the camera housing 105, image sensor 205, display screen 115 and primary and secondary apertures 125, 300 to be of almost any size, and thus embodiments of the present invention can be incorporated into various electronic devices such as mobile phones, personal digital assistants (PDAs), and notebook computers.

The present invention therefore provides a multi-direction image capture apparatus, such as the telephone 100, which enables images to be captured through either the primary aperture 125 or the secondary aperture 300 using only a single image sensor 205. In various circumstances the telephone 100 can, for example, rotate randomly about a lanyard hung around a user's neck and yet generally capture images of objects positioned in front of the user, without requiring any adjustments to the components of the telephone 100. Further, the primary aperture 125 or the secondary aperture 300 can be covered deliberately by a user so as to select a particular image capture direction.

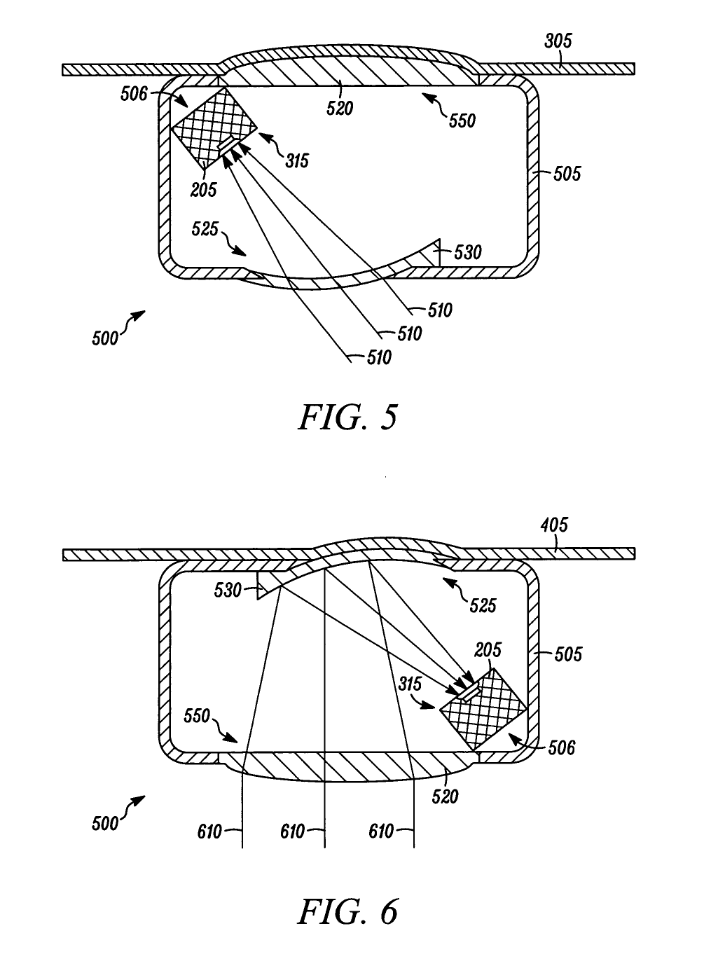

Referring to FIGS. 5 and 6 a schematic diagram of top sectional view of a second embodiment of a mobile telephone 500 is illustrated. As shown, the image sensor 205 is located near a corner 506 of housing 505. A one-way mirror 530 is oriented in a primary aperture 525, and of such a parabolic shape, so that light rays 510 passing therethrough are directed by the one-way mirror 530 to the light sensitive data capture surface 315. Also, light rays 610 passing through a secondary aperture 550 within which is located a secondary lens 520, are directed via the parabolic reflective surface of the one-way mirror 530 to the light sensitive data capture surface 315.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A multi-direction image capture apparatus, comprising:
a housing having a primary aperture and a secondary aperture;
an image sensor positioned in the housing and having a light sensitive data capture surface facing the primary aperture; and
a one-way mirror facing the light sensitive data capture surface of the image sensor, whereby light passing through the primary aperture passes through the one-way mirror and impacts the light sensitive data capture surface of the image sensor, and light passing through the secondary aperture is reflected off the one-way mirror and impacts the light sensitive data capture surface of the image sensor.

2. The apparatus of claim 1, wherein the one-way mirror is parabolic.

3. The apparatus of claim 2, wherein the light sensitive data capture surface of the image sensor is positioned at a focal point of the one-way mirror.

4. The apparatus of claim 1, wherein the one-way mirror is a lens positioned in the primary aperture.

5. The apparatus of claim 1, further comprising a lens positioned in the secondary aperture.

6. The apparatus of claim 1, further comprising a moveable defilade cover attached to the housing for covering the primary aperture.

7. The apparatus of claim 1, further comprising a moveable defilade cover attached to the housing for covering the secondary aperture.

8. The apparatus of claim 1, wherein the one-way mirror comprises thin film or polarized coatings.

9. The apparatus of claim 1, wherein the image sensor comprises a digital camera sensor.

10. The apparatus of claim 1, wherein the housing comprises an oblong shape, whereby when the apparatus hangs from the neck of a user either the primary or the secondary aperture is generally covered by the body of the user.

11. The apparatus of claim 1, wherein the light sensitive data capture surface is positioned at an angle relative to the primary aperture.

12. The apparatus of claim 1, wherein the light sensitive data capture surface is aligned so that a centerline passing through a center of the primary aperture and a center of the secondary aperture, also passes through a center of the light sensitive data capture surface.

13. The apparatus of claim 1, wherein the light sensitive data capture surface is offset so that a centerline passing through a center of the primary aperture and a center of the secondary aperture, does not pass through a center of the light sensitive data capture surface.
